(19) United States
(12) Patent Application Publication
(10) Pub. No.: US 2008/0016916 A1
(43) Pub. Date: Jan. 24, 2008

(54) Stamped glass

(76) Inventor: Wei Ye Yang, Xi'an (CN)

Correspondence Address: DERGOSITS & NOAH LLP, FOUR EMBARCADERO CENTER, SUITE 1450, SAN FRANCISCO, CA, 94111, US

(21) Appl. No.: 11/717,923

(22) Filed: Mar. 13, 2007

(30) Foreign Application Priority Data
Apr. 28, 2006 (CN) 200620078894.7
Apr. 28, 2006 (CN) 200620078897.0

(51) Int. Cl. C03B 23/00

(52) U.S. Cl. 65/64

(57) ABSTRACT

Ornamental features are added to glass by heating a small area of the glass which causes the glass to soften. A stamp having a raised or recessed surface is then pressed against the soft glass to form an ornamental feature on the surface. The unheated glass remains cool and is hard to provide structural support to the glass as the stamp is pressed against the surface. The stamp is then removed and the heated glass with the ornamental feature is allowed to cool and harden.

### BACKGROUND

Glass is a silica based amorphous solid material that is produced by shaping the molten silica material and then letting it cool below the glass transition temperature. One of the most common uses for glass is in drinking cups. Various shapes of drinking cups have been used for specific types of beverages. Water, sodas, milk, juice and many alcoholic beverages are used with glasses that typically have a flat base and cylindrical or conical body that maximizes the volume of liquid that can be contained in the glass. The sidewalls may be straight or curved. The axial cross section of the glass is typically circular but may be any other geometric shape.

Drinking glasses can be formed into many different shapes using various techniques. The glass can be machine molded or shaped using a hand blowing process. In the molding processes, machines heat the glass until it becomes liquid. A small piece of incandescent liquid glass is then dropped into the press machine mold and a plunger presses the glass against the mold. The mold is a multiple piece mold that fits together to form the desired external surfaces of the glass. The glass forms to the interior surface of the mold and the exterior surface of the plunger. The glass cools and hardens in the mold. The mold is then opened and the hardened glass is removed from the mold. The glass then passes in front of burners that melt any little defects away which gives the glass a smooth and shiny appearance.

Blown glass is another method used to manufacture drinking glasses. A tube known as a blowpipe or pontil is used to form the blown glass. The blowpipe can be made of iron or steel and is usually about five feet long. One end of the tube has a mouthpiece and the opposite end is a gather that contacts the glass. The blown glass fabrication process includes the steps of placing a small piece of liquid glass known as a gob on the gather at the end of a blowpipe. A mouthpiece is formed at one end of the blowpipe and a metal ring that helps to retain a gather can be attached to the other end of the blowpipe. The glass blower also known as a gaffer blows through the blowpipe causing the gob of liquid glass to inflate into a bulb. The gob is then manipulated into the required form. Various other process steps can be used to form the desired shape. The gaffer may change the shape by swinging the blown gob at the end of the blowpipe. The gob may be rolled on a marver which is a smooth, flat surface, to smooth the glass or to consolidate applied decorations.

The glass can also be formed with a combination of blowing and molding. The gaffer forms the gob into a rough shape and then places the partially formed gob into a finishing mold where it is blown into its definitive shape. The upper part of the glass is separated by a cutter at a very high temperature. The drinking glass fabrication processes ends with the annealing of the glass, this eliminates the internal tensions in the glass makes it stronger. Drinking glasses can also be toughened to allow them to withstand high thermal and physical stress.

There are several differences in the finished products of molded and blown glass. Although molded glass can be formed in many different shapes, the surface finish is inferior to blown glass. The molded glass assumes the surface finish of the mold, thus any defects in the mold are transmitted to the glass. Blown glass has a very smooth finish but the surface cannot be formed into complex shapes without using a mold which deteriorates the surface finish. What is needed is a method for forming complex features into the surface of a blown glass surface without compromising the surface finish.

### SUMMARY OF THE INVENTION

The inventive glass marking system is used to form ornamental features on the surface of a glass structure using a stamp. Raw glass is first melted from glass pieces or a mixture of ingredients. By mixing ingredients, different glass characteristics can be obtained such as color and structure. The glass mixture is melted and kept hot as it is formed into the desired shape. The melted glass is manipulated into the desired glass structure typically in a molding or glass blowing process. Once the formed glass structure has cooled and hardened, the glass structure can be handled.

The inventive process modifies the glass structure by adding markings to one or more small areas of the glass. A small area of the glass is heated with a hand held torch by holding the hot flame over the area while the surrounding glass remains cool. This heating causes a small area of the glass to become soft while the surrounding cooler glass remains rigid and provides structural support for the soft glass. Once the small area of glass is soft, it can be stamped.

In an embodiment, the stamp is an elongated device having a stamping surface and a handle section. The stamp surface can have raised or recessed features that create an ornamental pattern when pressed into the glass. The stamp surface can be made of a heat resistant material such as brass or other metal alloys. The handle is opposite the stamp surface and is thermally isolated so that when the stamp surface is pressed against the glass, much of the heat is not transferred to the handle. When the stamp is used, the user holds the handle and controls the contact between the stamp surface and the glass. The handle can be made of a material that does not conduct heat well such as wood, plastic, ceramic, or a combination of materials which prevent the handle from getting too hot when the stamp end is pressed into the partially melted glass. In order to avoid injury, the users of the stamp may also wear heat resistant gloves while handling the stamp and the glass structure. Alternatively, the users may use tools that allow the glass and stamp to be handled without burning the user's hands.

### BRIEF DESCRIPTION OF THE DRAWINGS

FIG. 1 is a side view of a stamp used to create marks in glass structures;

FIG. 2 is a view of the stamp end with raised features;

FIG. 3 is a view of the stamp end with recessed features;

FIG. 4 is a side view of a drinking glass being heated with a hand torch;

FIG. 5 is a side view of a stamp being pressed into the drinking glass;

FIG. 6 is a side view of the drinking glass with the formed mark;

FIG. 7 illustrates a jig used to properly position the glass and stamp.

### DRAWING REFERENCE NUMBERS

101 stamp

105 stamping surface

107 handle end

121 raised features

123 base

127 side edge

131 recessed feature

133 center circle

137 side edge

141 drinking glass

142 wine glass

143 torch

145 small area of glass

147 flame

149 mark

801 jig

803 glass

805 stamp

809 small area of the glass

811 hole

813 positioning column

### DETAILED DESCRIPTION

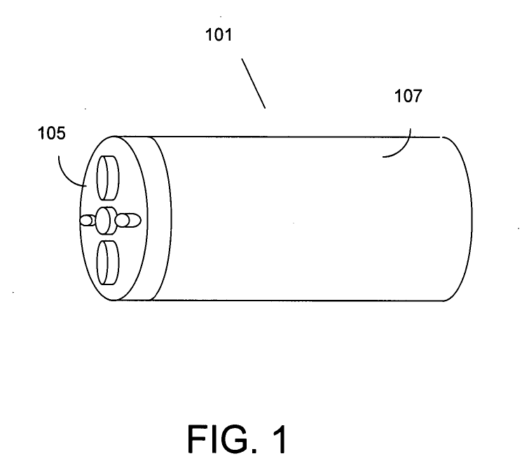

The inventive glass marking system is used to form ornamental features on the surface of a blown glass structure using a stamp. With reference to FIG. 1, the stamp 101 can be a hand held device having a stamping surface 105 with raised and/or recessed features and a handle end 107, which is thermally isolated from the stamp end 105. Although the stamp 101 is illustrated as having a cylindrical shape with a circular cross section, it can be any other elongated shape.

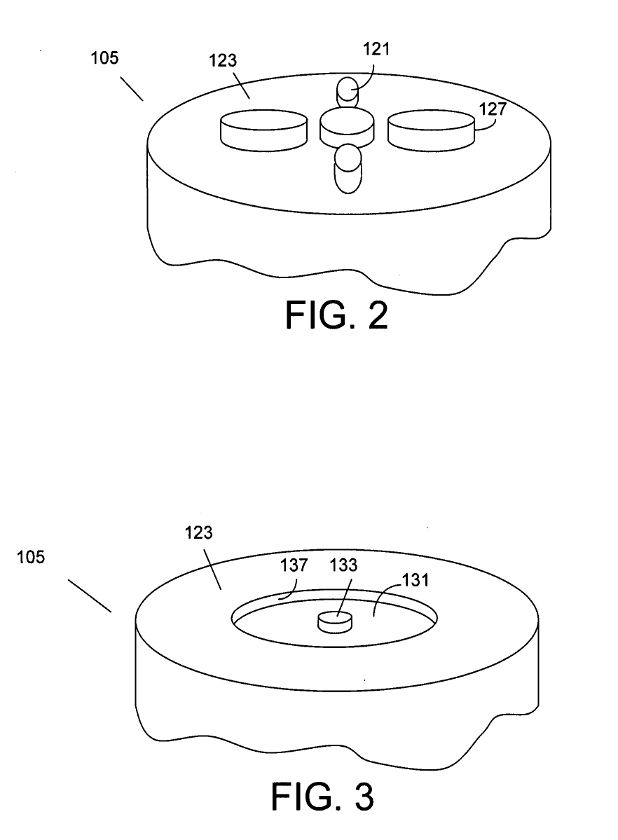

FIGS. 2 and 3 illustrate detailed views of the stamp end 105. FIG. 2 shows a detailed view of the stamp end 105 having raised features 121 that extend above from a base 123 which may be planar. In this example, four elongated features 121 surround a single circular center feature 121 and the side edges 125 of raised features 121 are substantially vertical and all substantially the same height. In other embodiments, the pattern of features 121 can be any other configuration of patterns and/or shapes also the side edges 125 may be angled or curved inward from the base 123 to the top of the raised features 121.

The raised features 121 are pressed into a small area of hot glass that is pliable. In order to avoid adhesion between the features 121 and the glass, the side edges 127 of the features 121 should always be perpendicular or angled inward from the base 123. The side edges 127 should not form an overhang with the base 123 that might trap some of the glass and prevent the stamping surface 105 from being removed from the glass after the mark is formed.

FIG. 3 illustrates a stamp end 105 that has recessed features 131. In this example, the recessed feature 131 is an annular shape that is recessed below the base 123. The center circle 133 may have a surface that is planar with the base 123. The recessed feature 131 may also have side edges 137 that intersect the base 123. Like the raised features, the side edges 137 of the recessed features 131 should be perpendicular or angled inward from the base 123. The side edges 137 should not be angled outward to avoid trapping glass when the stamp 101 is used to form a mark on a glass. In other embodiments, any other pattern of recessed features and/or raised features can be used to form the stamp end. The base 123 and features 121 may be made of a single piece of material that has a high melting temperature and is heat resistant, such as brass.

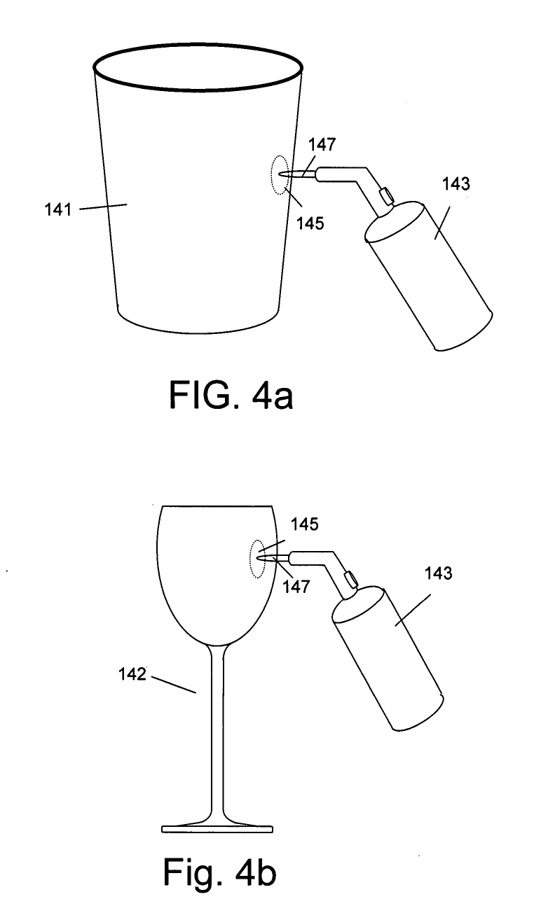

FIGS. 4-6 illustrate the process by which the inventive stamp is used. A glass structure is formed either from a machine mold or through a glass blowing process. The glass structure is allowed to cool, so that the glass hardens. With reference to FIGS. 4a and 4b, because the walls of glass to be marked may be thin, it is desirable to keep the height of the raised or recessed features of the stamp proportional to the thickness of the glass wall. Higher raised surfaces can be used with thicker glass such as the drinking glass 141 shown in FIG. 4a but a smaller raised surface height should be used with thin glass such as wine glass 142 shown in FIG. 4b. The raised or recessed features should be large enough so that the marks created in the glass are easily seen after the stamp is pressed against the glass, but not so large that the indentations formed in the glass would creating a thin weak spot or even holes in the glass. Once the glass is cool and strong enough to handle, a torch 143 is used to heat a small area 145 of the glass structure 141. The flame 147 is directed at the small area 145 and held there until the glass gets soft. A thin glass wall wine glass 142 shown in FIG. 4b will require less heat to soften than a thicker wall drinking glass 141 shown in FIG. 4a.

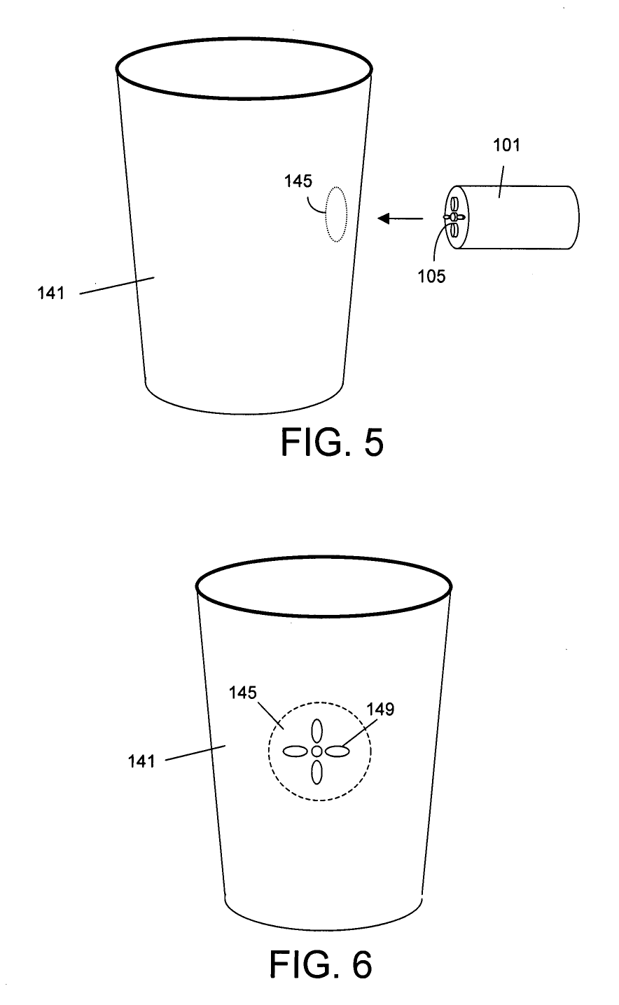

With reference to FIG. 5, as soon as the flame is removed from the small area of glass 145, the stamp 101 is pressed against the small heated area 145. The glass surrounding the small heated area 145 should be strong enough to support the small area 145 when the stamp 101 is pressed against it. The stamp 101 may be pressed against the glass until the small area of softened glass 145 substantially surrounds the features of the stamping surface 105. The glass should flow around the raised surfaces and/or contact the recessed features of the stamping surface 105. Because the glass 145 is very hot, the handle portion of the stamp 101 should be made of an insulative material that prevents heat from being transferred through. With reference to FIG. 6, once the impression is made, the stamp 101 is removed and the mark 149 remains in the small heated area of glass 145.

The described glass marking process can be repeated until the glass is marked as desired. For example, a number of markings can be applied around the perimeter of the glass as well as the base. The same marking or different markings can be used. In order to avoid damage, the glass may be allowed to cool before any sequential markings are stamped. Alternatively, an area of glass that is sufficiently far away from the small heated area may be heated so that the surrounding glass is cool and can provide strength. By alternating sides of the glass to heat, the glass can be more quickly stamped multiple times.

The stamps can be ornamental and have a variety of shapes, patterns and finishes. Although the stamps that have been described are generally ornamental, it is also possible to provide informational markings such as a plurality of alpha-numeric characters or symbols. For example, a glass can be personalized with a series of stamped letters to create initials or names. Thus, one or more glasses can be marked with the initials or names of the user or owner. Each of the glasses may have a marker indicating the person using the glass. It is also possible to a set of glasses having monogram lettering. Alternatively, messages can also be created using a series of letter markings. The inventive stamping process can be an inexpensive alternative, to other glass marking processes such as glass etching which require large runs and special etching masks to be made.

One of the primary benefits of the inventive system is that it provides an inexpensive means for producing customized glass pieces. A normal set of glasses that have any custom markings can require special tooling to create the desired design. The special tooling can be custom molds to create the entire glass piece. If an etching process is used, custom masks are required to form the desired etch pattern. Very large production runs are required to make such tooling cost effective.

In contrast, the inventive glass stamping process is much more cost effective because the stamps are inexpensive to produce and the desired glass markings can be created use combinations of simple stamps. For example, a glass having a word would require either special molding or a special mask for the word. The inventive system is less expensive because the word can be created with a combination of letter stamps.

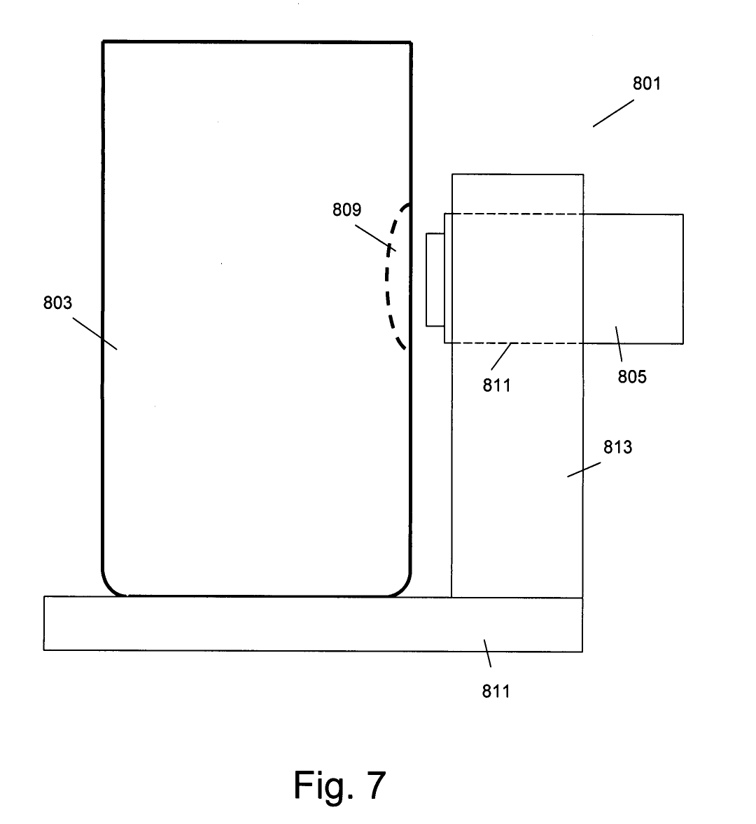

The inventive glass stamping process has been described as a hand process, which must be repeated if multiple glasses are being produced with the same stamped markings. The uniformity of the stamp markings may be difficult if all stamping steps are performed by hand. With reference to FIG. 7, a jig 801 can be used to properly position the stamps to that the marking can be placed in the same location on all of the glasses 803. The jig 801 may have a base 811, a positioning column 813 and a hole 811 in the positioning column 813 corresponding to the body of the stamp 805. Although the body of the stamp 805 has been illustrated as a circular cross section, this maybe problematic because the circular shape allows the stamp 805 to rotate within the hole 811. It may be desirable to use a stamp 805 having a square cross section and a corresponding square hole 811. In other embodiments, various other cross section shapes can be used.

After heating the small area of the glass 809, the glass 803 is positioned on the jig 801 to that the small area of glass 809 is aligned with the hole 811. The glass 803 is held in place while the stamp 805 is pressed against the small area 809. The glass 803 is then removed so that the small area of glass 809 can cool and the described process can be repeated with other glasses 803 to produce a set which each having uniform stamped markings.

Although the present invention has been described with reference to specific exemplary embodiments, it will be evident that various modifications and changes may be made to these embodiments without departing from the broader spirit and scope of the invention as set forth in the claims. For example, although the specification describes the marking of drinking glasses with the stamp, the inventive method can also be used with any other type of glass structures including: vases, ornaments, windows, doors, tables, eyeglasses, lamps, etc. Accordingly, the specification and drawings are to be regarded in an illustrative rather than a restrictive sense.

What is claimed is:

1. A method for forming an ornamental feature on a glass structure comprising the steps:
forming the glass structure from a heated gob that is attached to a blowtube;
cooling the glass structure until the glass structure hardened;
providing a stamp having a stamping surface;
heating a small area of the glass structure that is smaller than three inches in diameter until only the small area of glass becomes pliable and an annular area of glass surrounding the small area provides physical support;
pressing the stamping surface against the small area of glass that was heated to form the ornamental feature;
removing the stamping surface from the small area of glass; and
cooling the small area of glass to ambient temperature to harden the ornamental feature.

2. The method of claim 1 wherein the stamping surface of the stamp is made of brass.

3. The method of claim 1 wherein the stamp includes a handle that is thermally isolated from the stamping surface.

4. The method of claim 1 wherein the glass is a drinking cup.

5. The method of claim 1 wherein the heating step is performed with a handheld torch.

6. The method of claim 1 wherein the cooling step is performed in an annealer.

7. A method for forming an ornamental feature on a glass structure comprising the steps:
forming the glass structure;
providing a stamp having a stamping surface with protruding features;
heating a small area of the glass structure that is less than about three inches in diameter until the small area of glass becomes pliable and an annular area of glass surrounding the small area provides physical support;
pressing the stamping surface of the stamp against the small area of glass to form the ornamental feature;
removing the stamping surface from the small area of glass; and
cooling the small area of glass to ambient temperature to harden the ornamental feature.

8. The method of claim 7 wherein the stamping surface is made of brass.

9. The method of claim 7 wherein the stamp includes a handle that is thermally isolated from the stamping surface.

10. The method of claim 7 wherein the glass is a drinking cup.

11. The method of claim 9 wherein the heating step is performed with a handheld torch.

12. The method of claim 9 wherein the cooling step is performed in an annealer.

13. A method for forming an ornamental feature on a glass structure comprising the steps:
forming the glass structure;
providing a stamp having a stamping surface with recessed features;
heating a small area of the glass structure that is smaller than three inches in diameter until the small area of glass becomes pliable and an annular area of glass surrounding the small area provides physical support;
pressing the stamping surface against the small area of glass to form the ornamental feature;
removing the stamping surface from the small area of glass; and
cooling the small area of glass to ambient temperature to harden the ornamental feature.

14. The method of claim 13 wherein the stamping surface of the stamp is made of brass.

15. The method of claim 13 wherein the stamp includes a handle that is thermally isolated from the stamping surface.

16. The method of claim 13 wherein the glass is a drinking cup.

17. The method of claim 13 wherein the heating step is performed with a handheld torch.

18. The method of claim 13 wherein the stamping surface is radially symmetric.

19. The method of claim 13 further comprising the step:
providing a jig; and
placing the glass structure on the jig;
wherein the jig holds the stamp during the pressing step.

20. The method of claim 19 wherein the jig allows the stamp to move horizontally during the pressing step.
